(19) United States
(12) Patent Application Publication
(10) Pub. No.: US 2012/0319403 A1
(43) Pub. Date: Dec. 20, 2012

(54) Wheel Turbine Rotor

(76) Inventor: George A. Fosdick, Middletown, CT (US)

(21) Appl. No.: 13/476,775

(22) Filed: May 21, 2012

Related U.S. Application Data
(60) Provisional application No. 61/519,288, filed on May 20, 2011.
(60) Provisional application No. 61/541,196, filed on Sep. 30, 2011.

(51) Int. Cl. F01D 5/02; F03B 15/06; F01D 5/14; H02K 7/18

(52) U.S. Cl. 290/7; 290/52; 416/223 A

(57) ABSTRACT

A turbine rotor is provided and includes a rotor plate, wherein the rotor plate is substantially circular in shape and includes a rotor plate surface having a rotor plate center and a rotor plate periphery. The turbine rotor further includes a plurality of rotor blades, wherein the plurality of rotor blades are associated with the rotor plate to be located proximate the rotor plate periphery and to extend out of and away from the rotor plate surface, wherein the rotor plate is configured to be attached to a turbine shaft that rotates about a shaft axis, such that when the turbine shaft rotates about the shaft axis, the rotor plate rotates about the shaft axis.

### CROSS REFERENCE TO RELATED APPLICATIONS

This application is related to and claims the benefit of the filing dates of U.S. Provisional Patent Application Ser. No: 61/519,288 filed May 20, 2011 and U.S. Provisional Patent Application Ser. No: 61/541,196 filed Sep. 30, 2011, the contents of which are incorporated herein by reference in their entireties.

### FIELD OF THE INVENTION

The present invention relates generally to a device for converting wind power into electric energy and more particularly to a wheel turbine rotor for use with wind powered electric generators.

### BACKGROUND OF THE INVENTION

Wind turbines are devices that convert kinetic energy from the wind into mechanical energy. Currently, conventional wind turbines use a multi-blade design (such as a three blade propeller type design) to capture and convert this wind energy into mechanical (rotational) movement which is then converted into electrical energy by a rotor. This is typically accomplished by configuring the blades of the device (commercial production of electric power employ a three-bladed configuration) to be substantially perpendicular to the direction of wind flow, where the design of the blade converts the wind flow into rotational mechanical energy.

Unfortunately however, according to Betz's law, because no turbine can capture more than 59.26% of the kinetic energy in wind flow across the swept area, the maximum amount of recoverable energy that can be extracted is theoretically limited. In fact, current conventional wind turbines are not able to capture anywhere near the Betz limit of energy and the majority of the kinetic energy of wind is not captured and is lost.

Although advances in wind turbine technology and blade design have been made, such as unique placements of the turbines relative to the wind flow as well as using more energy efficient and lighter materials, the amount of kinetic energy capturable is still governed by the Betz limit and is thus, limited.

### SUMMARY OF THE INVENTION

A turbine rotor is provided and includes a rotor plate, wherein the rotor plate is substantially circular in shape and includes a rotor plate surface having a rotor plate center and a rotor plate periphery. The turbine rotor further includes a plurality of rotor blades, wherein the plurality of rotor blades are associated with the rotor plate to be located proximate the rotor plate periphery and to extend out of and away from the rotor plate surface, wherein the rotor plate is configured to be attached to a turbine shaft that rotates about a shaft axis, such that when the turbine shaft rotates about the shaft axis, the rotor plate rotates about the shaft axis.

A turbine system for converting fluid flow into electricity is provided and includes a turbine rotor, a rotor shaft, wherein the rotor shaft is associated with the turbine rotor such that rotation of the turbine rotor generates rotation of the rotor shaft and an electricity generation device. The electricity generation device is associated with the rotor shaft and configured to generate electricity in response to the rotation of the rotor shaft. The turbine rotor includes a rotor plate, the rotor plate being substantially circular in shape and including a rotor plate surface having a rotor plate center and a rotor plate periphery and a plurality of rotor blades, wherein the plurality of rotor blades are associated with the rotor plate to be located proximate the rotor plate periphery and to extend out of and away from the rotor plate surface, wherein the rotor plate is configured to be attached to a turbine shaft that rotates about a shaft axis, such that when the turbine shaft rotates about the shaft axis, the rotor plate rotates about the shaft axis.

A method for converting a fluid flow into electrical energy is provided and includes associating a turbine rotor with an electrical energy generation device via a turbine shaft, such that rotation energy from the turbine rotor is communicated to the electrical generation device via the turbine shaft, wherein the turbine rotor includes a rotor plate, the rotor plate being substantially circular in shape and including a rotor plate surface having a rotor plate center and a rotor plate periphery; and a plurality of rotor blades, wherein the plurality of rotor blades are associated with the rotor plate to be located proximate the rotor plate periphery and to extend out of and away from the rotor plate surface, wherein the rotor plate is configured to be attached to a turbine shaft that rotates about a shaft axis, such that when the turbine shaft rotates about the shaft axis, the rotor plate rotates about the shaft axis. The method further includes positioning the turbine rotor such that at least a portion of a fluid flow is incident on the turbine rotor to cause the turbine rotor to generate rotational energy, wherein the rotational energy is received by the electrical energy generation device and converted into electrical energy.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike in the several Figures:

FIG. 1 is a front view of the wheel rotor plate in accordance with one embodiment of the present invention.

FIG. 2 is a scaled-up view of the blade portion of the wheel rotor plate of FIG. 1.

FIG. 3 is a top down view of the cambered blade of the wheel rotor plate of FIG. 1.

FIG. 4 is a side view of the wheel rotor plate of FIG. 1 showing airflow incident on the wheel rotor plate when the wheel rotor plate is perpendicular to the direction of airflow.

FIG. 5 is a side view of the wheel rotor plate of FIG. 1 showing airflow incident on the wheel plate when the wheel plate is perpendicular to the direction of airflow.

FIG. 6 is a front view of the wheel rotor plate of FIG. 1 showing airflow through flow blade channels.

FIG. 7A is a side view of a wheel rotor plate in accordance with an additional embodiment, where the wheel rotor plate is convex.

FIG. 7B is a side view of a wheel rotor plate in accordance with an additional embodiment, where the wheel rotor plate is concave.

FIG. 8A is a side view of a wheel system with the wheel rotor plate of FIG. 1, showing the wheel rotor plate of FIG. 1 in a first configuration.

FIG. 8B is a side view of a wheel system with the wheel rotor plate of FIG. 1, showing the wheel rotor plate of FIG. 1 in a second configuration.

FIG. 8C is a side view of a wheel system with the wheel rotor plate of FIG. 1, showing the wheel rotor plate of FIG. 1 in a third configuration.

FIG. 9 is a side view of the wheel rotor plate of FIG. 1 showing airflow incident on the back surface of the blades of the wheel rotor plate when the wheel rotor plate is parallel to the direction of airflow.

FIG. 10 is an operational block diagram of one embodiment of a method for implementing the wheel rotor plate of FIG. 1.

### DETAILED DESCRIPTION OF THE INVENTION

In accordance with the present invention, an improved wheel rotor having a rotor plate with a plurality of rotor blades located on the rotor plate, where the blades may be located proximate to (or inboard from) the periphery of the rotor plate. It should be appreciated that the rotor design advantageously harnesses wind energy by directing and/or accelerating the ambient wind-speed to the blades. The design of the wheel rotor of the present invention allows for relatively quiet operation, increased operating versatility (i.e. may be used on land or in water), and is environmentally safer than current three-blade designs. The present invention's wheel rotor plate design presents a solid and visible object which birds are more likely to recognize and avoid. Thus, the wheel rotor of the present invention may be used in migratory path areas.

Additionally, the wheel rotor of the present invention is scalable depending upon application. For example, the wheel rotor of the present invention can be used as a small scale and as may act as a power source for a building (or parts of the building) or the wheel rotor of the present invention may be used as a large scale power source for a geographical area. Furthermore, unlike current windmill designs, turbines that use the wheel rotor of the present invention may be used in an unrestricted manner because it operates at lower wind speeds and does not “throw blades”. Because the wheel rotor of the present invention can be installed in areas of lower wind speeds, design and installation costs for the present invention would be lower than current systems. It should also be appreciated that the wheel rotor of the present invention may also be used with other fluids as well, such as water. It should also be appreciated that the wheel rotor 100 of the present invention has several advantages in performance, maintenance and safety.

The design and orientation of the wheel rotor of the present invention increases torque unlike standard foil designs (which work by producing lift). Thus, the wheel rotor of the present invention results in a yield of much more power at lower wind speeds than current systems. In accordance with the present invention, the wheel rotor of the present invention forces the air/fluid to engage with the blades/foils which may be oriented and distributed equally around (or proximate to) the periphery of the rotor. This is accomplished when the swept area of the rotor captures the incident laminar wind and redirects the airflow axially, forcing the airflow towards the rotor periphery and against the foils. In one embodiment, these cambered foils may be configured at approximately a 90° angle relative to the back plate of the rotor. In other embodiments, the cambered foils may be configured to be angled within a range of angles between 15° and 55° relative to the back plate of the rotor. This redirected airflow generates a centrifugal force and creates a negative pressure system at the leading edge of the foils. As a result a vacuum is created at the periphery of the wheel rotor inducing ‘horizontal lift’ (i.e. ‘lift’ relative to the front surface and/or back surface of the blade) and removing the air/fluid from the wheel rotor at a faster rate, and allowing for efficient operation.

The blades/foils of the wheel rotor of the present invention are unique in that they cut into the air in a horizontal manner making their design extremely aerodynamic and stable while displaying virtually no turbulence. Due to its design, the wheel rotor of the present invention produces torque and does not rely predominantly on lift as do conventional wind turbines. It should be appreciated that the design of the wheel rotor of the present invention is not governed and thus not limited by Betz's law which theorizes that no turbine can capture more than 59.26 percent of the kinetic energy of a wind flow. The practical significance of this is that it limits the maximum power that can be extracted from airflow, independent of the rotor design. Accordingly, the Betz limit basically states that only 59.26% of the swept wind can be converted into kinetic energy and thus, wind turbines that are governed by Betz's law can never achieve efficiency greater than 59.26%. For example, an extremely efficient modern wind turbine only achieves approximately 30%-40% efficiency. The wheel rotor of the present invention is not bound by the same assumptions and inefficiencies as traditional turbine rotors. One reason for this is that each successive cambered blade ‘helps’ the blade behind it by creating a peripheral vacuum. As a result, not only can the air not escape, the airspeed is actually accelerated and forced to the periphery of each blade.

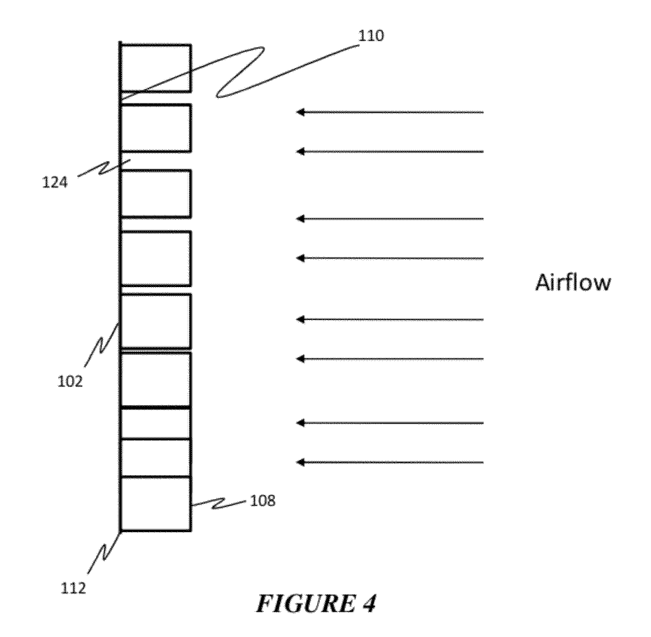

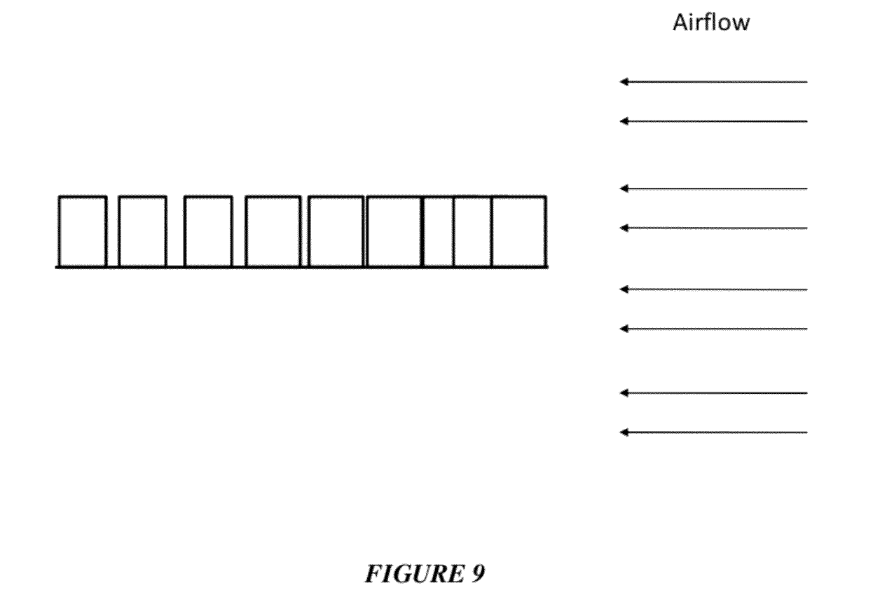

Furthermore, the wheel rotor of the present invention is operational in multiple planes. For example, as discussed further herein the wheel rotor of the present invention is operational at angles between 0° (See FIG. 4) and 180° (See FIG. 9) relative to the direction of incident fluid flow. Moreover, it should be appreciated that although as disclosed herein the blade/foils are shown being located along the entire circumference of the periphery of the rotor plate, it is contemplated that the blade/foils may be staggered along the circumference of the rotor plate so as not to completely surround the rotor plate so long as flow channels (as discussed herein) exist between adjacent blades. For example, every sixth (or so) blade there may be a gap. Moreover, it is also contemplated that some or all of the blades may be located in other various areas away from the periphery of the blade plate as desired, such as toward the center of the blade.

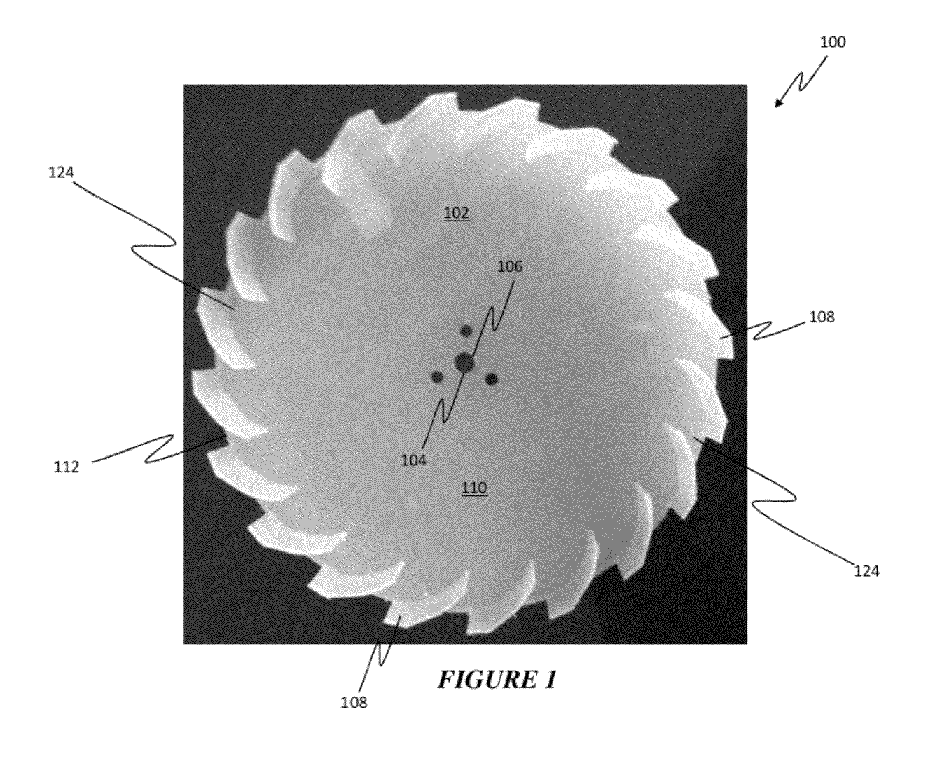

Referring to FIG. 1, an improved wheel rotor 100 is provided and includes a wheel rotor plate 102 having a shaft opening 104 for mounting the rotor plate 102 onto a turbine shaft which rotates about a rotational axis 106, in accordance with one embodiment of the present invention. The rotor plate 102 is substantially flat and includes a plurality of cambered (or curved) blades (or wings) 108 located on the rotor plate surface 110 and located along the rotor plate periphery 112. It is contemplated that blades 108 may be located anywhere along the rotor plate surface 110 in a manner suitable to the desired end purpose. For example, blades 108 may be located towards an inner section of the rotor plate surface 110 (i.e towards center of rotor plate surface 110) to increase or decrease rotation speed of the rotor plate 102, as desired. The blades 108 include a blade length (i.e. length between opposing ends of blade 108) and a blade width (i.e. extending out of the rotor plate surface 110) and are configured to be substantially perpendicular to the rotor plate surface 110 and to extend out of and away from the rotor plate surface 110 by approximately ⅛ of the diameter of the rotor plate 102. For example, if the rotor plate 102 has a diameter of 8 inches, then the blades 108 extend out of the rotor plate 102 by approximately 1 inch. However, it should be appreciated although the embodiment disclosed herein shows the blades 108 extending out of the rotor plate surface 110 by a length equal to approximately ⅛ of the diameter of the rotor plate 102, the blades 108 may extend out from the rotor plate 102 by any length suitable to the desired end purpose. It should be appreciated that the blade length may vary according to atmospheric pressure as discussed further hereinafter.

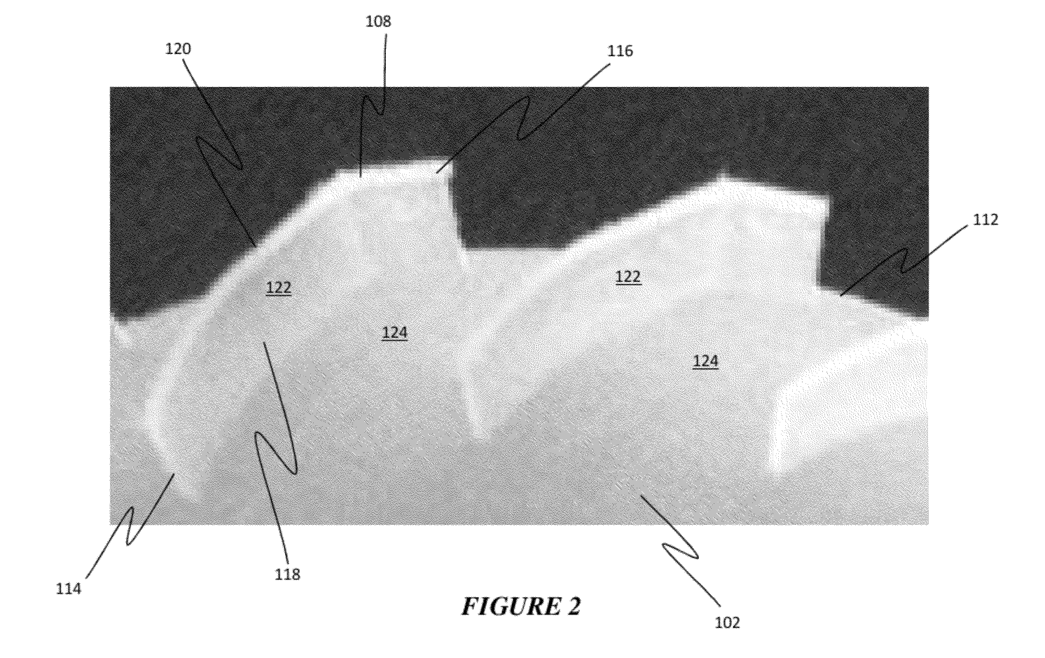

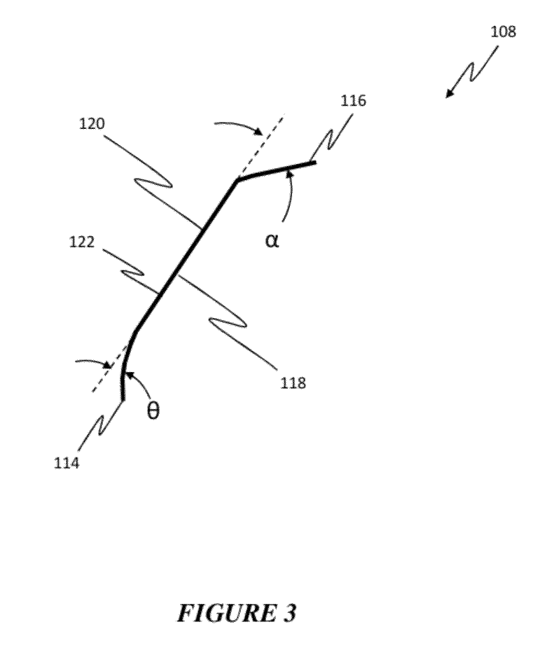

Referring to FIG. 2 and FIG. 3, each of the blades 108 includes a leading edge 114, a trailing edge 116, a front surface 118, a back surface 120 and a blade center portion 122 which separates the leading edge 114 from the trailing edge 116. Each of the blades 108 may be positioned relative to adjacent blades 108 such that a portion of the leading edge 114 of one blade may overlap (in a sagittal plane passing through both blades 108 and the center 104 of the rotor plate 102) the trailing edge 116 of the adjacent blade relative to a line drawn from the center 104 to the plate periphery 112 ((or there may be a slight space so that they may be close to overlapping, but not actually overlap). Additionally, each blade 108 may be positioned relative to the adjacent blades 108 such that a flow channel 124 is created between each blade 108 and its adjacent blade 108. Moreover, it should be appreciated that in one embodiment, a sagittal plane that intersects both the blade center portion and the rotor plate center is separated from a sagittal plane that is tangent to the blade center portion by an angle μ, where the angle μ may range from about 0° to about 90°. It should be further appreciated that the blades 108 may be automatically or manually configurable such that the angle μ is adjustable to be between about 0° to about 90°. Thus, any air flowing from the center of and along the rotor plate surface 110 toward the plate periphery 112 will impact the front surface 118 of the blades 108. Accordingly, the air flowing along the rotor plate surface 110 to the plate periphery 112 will flow into the flow channel 124 and impact the blades 108.

It should be appreciated that in one embodiment the angle 0 between the leading edge 114 and the blade center portion 122 is approximately 15° (±)5° and the angle a between the trailing edge 116 and the blade center portion 122 is approximately 54° (±)5°. However, it should be appreciated that any angle θ, α may be used as desired as long as the airflow is directed by the front surface 118 of the blade 108 to flow into and through the flow channel 124 and over the back surface 120 of the adjacent blade 108. It is contemplated that in other embodiments, all or portions of the blade 108 (i.e. leading edge 114, trailing edge 116, center portion 122) may be a continuous (or semi-continuous) curved or arc shaped surface. Moreover, it is contemplated that in some embodiments the leading edge 114 and/or trailing edge 116 may be configurable such that the angles θ, α relative to the blade center portion 122 may be automatically or manually changeable. Additionally, it is contemplated that in some embodiments, the orientation of the entire blade 108 may be automatically or manually changeable. Furthermore, it is contemplated that in some embodiments, the blades 108 may be adjustable in both length and width, as well. For example, depending on the wind conditions the length of the leading edge 114, trailing edge 116 and/or center portion 122 may be adjustable to be longer or shorter as desired. As another example, it may be advantageous to have the blade 108 extend from the rotor plate surface 110 by more or less than the approximate ⅛ of the diameter of the rotor plate 102. Thus, it is contemplated that in some embodiments, the width of the blade 108 may be automatically or manually changeable, as well. One such exemplary blade design is shown in U.S. Pat. No. 4,427,343, the contents of which are incorporated herein by reference in its entirety.

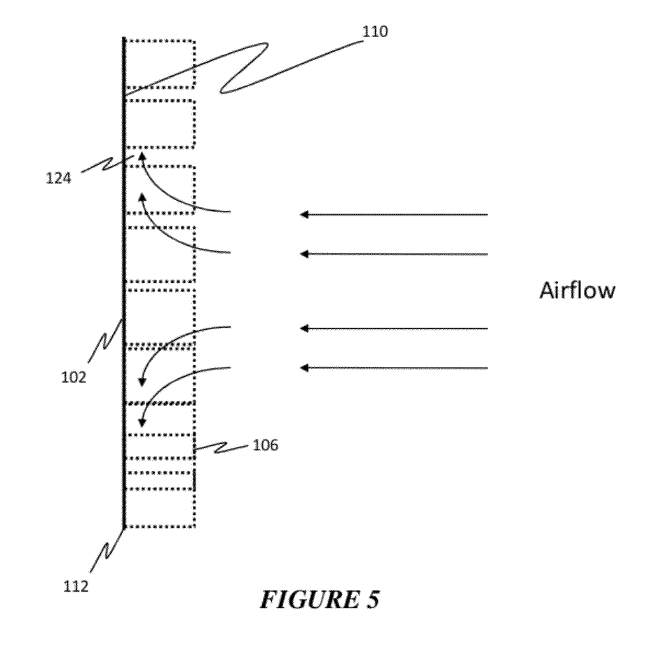

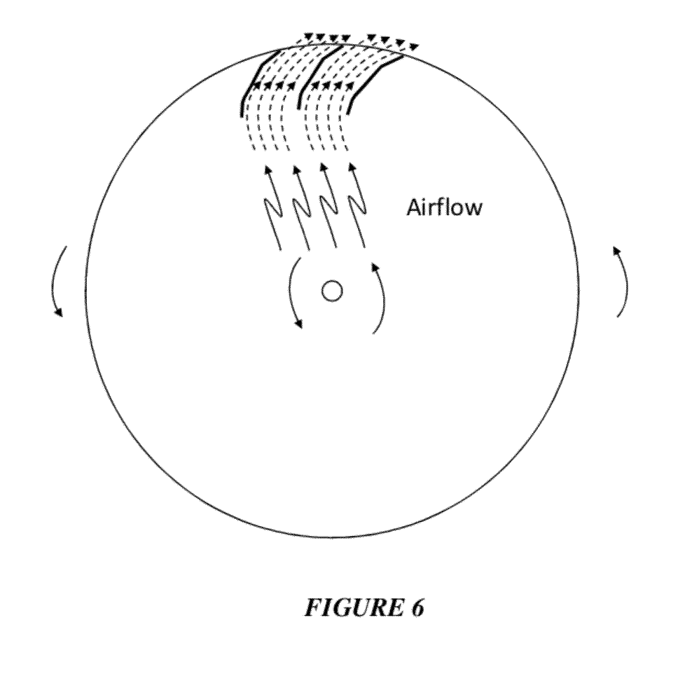

Referring to FIGS. 4-6, when the rotor plate 102 is placed in an airflow such that the airflow contacts the rotor plate surface 110 (See FIG. 4), the airflow is directed along the rotor plate surface 110 (i.e the swept area) towards the plate periphery 112 (See FIG. 5). Referring to FIG. 6, as the airflow 126 flows along the rotor plate surface 110 towards the plate periphery 112, the airflow 126 contacts the front surface 118 of the blade 108 and directs the airflow 126 through the flow channel 124 where the airflow 126 contacts and flows over the front surface 118 of the first cambered blade 128 and to flow over the rear surface 116 of the adjacent or second cambered blade 130. As the airflow 126 contacts the front surface 118 of the first blade 128 it produces a force on the front surface 118 on the first blade 128. Additionally, as the directed airflow flows over the rear surface 116 of the adjacent blade 130 this causes a reduction in pressure on the rear surface 116 of the adjacent blade 130. Thus, the cambered blade 106 acts similar to a wing. The force against the front surface 118 of the first blade 128 and the reduction in pressure in the area of the rear surface 116 of the second blade 130 causes the rotor plate 102 to rotate about the rotational axis 106 (which may be centered or off-center if desired) in the direction of the force being applied to the front surface 118 of the first blade 128.

It should be appreciated that the configuration of the present invention makes the rotor plate 102 function essentially like a “rotor blade” which captures all (or a large portion) of the airflow 126 in the swept area 110 and forces the airflow 126 across the rotor plate surface 110 in an essentially orthogonal direction toward the plate periphery 112 of the rotor plate 102 where the airflow 126 engages the blades 108. This causes the plate 102 to rotate about the rotational axis 106. Thus, this impeller like characteristic allows the wheel rotor 100 of the present invention to avoid the limitations of the Betz limit and in fact, exceed the Betz limit to maximize the energy conversion.

In accordance with the present invention, the configuration of the wheel rotor 100 allows the cambered blades 108 to act similarly to a wing thereby converting the wind energy into primarily torque rather than lift. This torque advantageously creates much more power than conventional designs at any airflow speed because conventional designs primarily produce lift and only secondarily produce torque. Thus, increased power results by using hyperbolic leverage via the spatially “overlapping” blades to optimize power.

It should be appreciated that in addition to the embodiments disclosed above, other embodiments of the present invention are also contemplated. For example, in another embodiment the rotor plate surface 110 may have raised and/or dimpled structures and/or openings to reduce and/or control turbulence of the airflow 126. In still yet another embodiment, the blades 108 may be movable (either manually, automatically or computerized and as a group or individually) to take advantage of the variations in airflow due to directional airflow variations or orientation of the wheel rotor plate 102. In still yet another embodiment, some or all of the blades 108 may be angled relative to the rotor plate surface 110 as opposed to being substantially perpendicular.

It should be appreciated that because the wheel rotor 100 of the present invention is more aerodynamic than conventional turbines blades, the wheel rotor 100 is able to ‘cut’ through the airflow 126 more easily thereby allowing the wheel rotor 100 to achieve higher RPM's with lower noise than the standard turbines having a three-blade configuration. It should be further appreciated that the present invention has additional low wind-speed advantages as well. Because the wheel rotor 100 out-performs conventional wind turbine rotors by a factor of 10 (or more), the wheel rotor 100 is more efficient. Because the wheel rotor plate 102 captures more wind energy, the wheel rotor 100 starts to rotate at lower airflow speeds than conventional wind turbines that use a three-blade configuration, making the wheel rotor 100 less likely to be idle. Thus, the wheel rotor 100 is better able to overcome the initial start up friction of the rotor, which requires the expenditure of a great deal more energy than keeping the turbine rotor in motion.

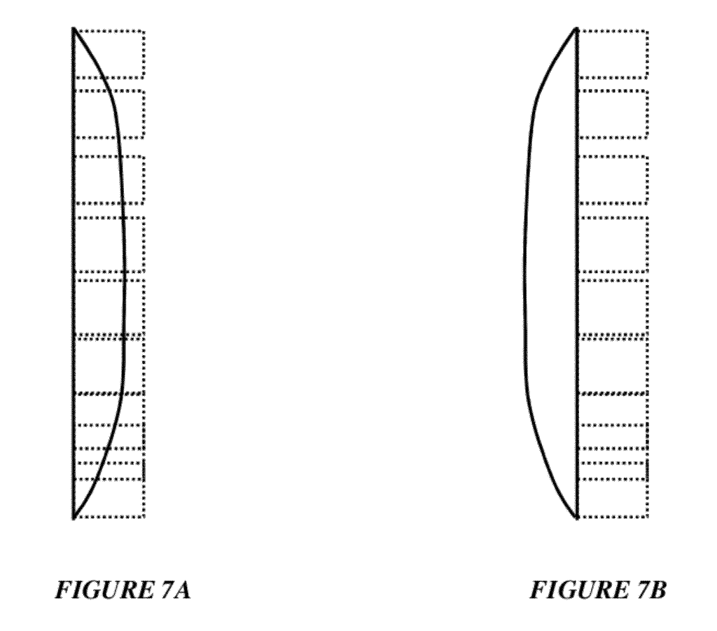

In accordance with still yet another embodiment of the present invention, the wheel rotor 100 may include a rotor plate that has a shaped surface to help direct the flow of fluid that is incident on the rotor plate to the blades. For example, in one embodiment the rotor plate may be a convexed rotor plate 402 (see FIG. 7A), while in another embodiment the rotor plate may be a concaved rotor plate 502 (see FIG. 7B).

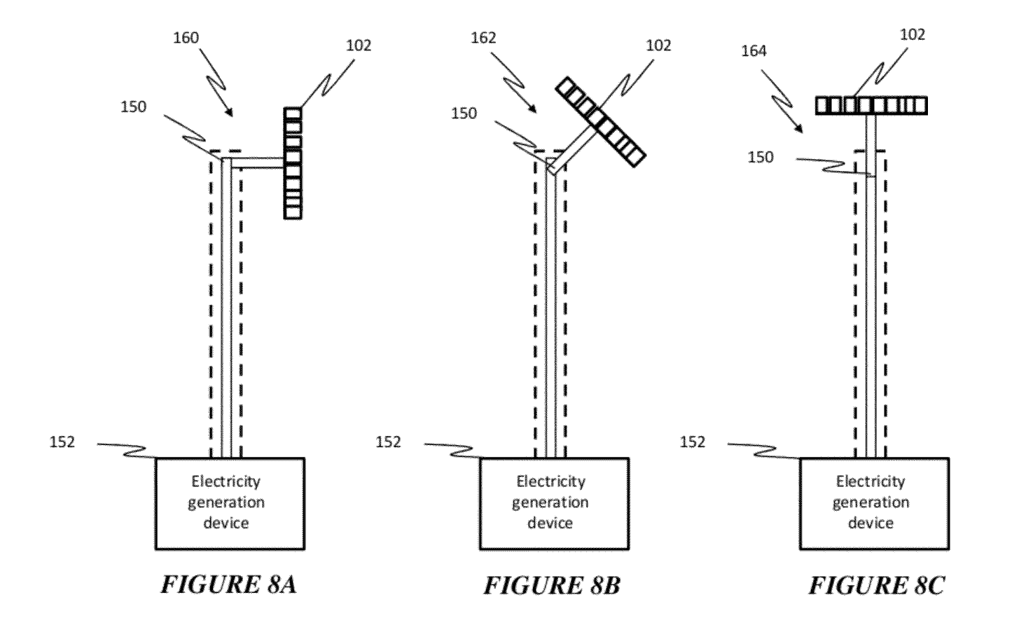

In accordance with still yet another embodiment of the present invention, it should be appreciate that the orientation of the wheel rotor plate 102 may be manually or automatically configurable based on preference and/or environmental conditions. Referring to FIG. 8A, FIG. 8B and FIG. 8C, the wheel plate 102 is shown connected to a turbine shaft 150 which is further connected to electricity generation equipment 152. When an airflow is incident on the wheel rotor plate 102, the wheel rotor plate 102 rotates causing the shaft 150 to rotate. This in turn may cause a rotor within electricity generation equipment 152 to rotate, thereby generating electricity for storage and/or distribution.

The wheel rotor plate 102 (or the entire wheel turbine system) is configurable between a first configuration 160 (See FIG. 8A), a second configuration 162 (See FIG. 8B) and a third configuration 164 (See FIG. 8C). When in the first configuration 160, the wheel rotor plate 102 is substantially perpendicular to the direction of airflow (as shown in FIG. 8A and FIG. 4) such that the airflow contacts the rotor plate surface 110. Accordingly the wheel rotor plate 102 may be receiving the full force of the airflow and thus may be completely operational and rotating. When in the third configuration 164, the wheel rotor plate 102 is substantially parallel (and the blades 108 are substantially perpendicular) to the direction of airflow so only the back surface 120 of the blades 108 are receiving the full force of the airflow (as shown in FIG. 9). In this configuration, the wheel rotor 100 may or may not be operational (such as during a storm where the RPM's are to be minimized or eliminated). This may also allow the wheel rotor 100 to be worked on and maintained safely. Thus, when in the first configuration 160, at least a portion of the shaft 150 of the wheel turbine system is in the vertical position and when in the third configuration 164, at least a portion of the shaft 150 of the wheel turbine system is in a substantially horizontal position. It should also be appreciated that the stable design of the cambered blades 108 advantageously allow for the wheel rotor 100 to still rotate (in a very stable manner) while in the third configuration 164, if desired. Thus, the wheel rotor 100 of the present invention is able to be used in severe weather. As shown in FIG. 8B, it is also contemplated that the wheel rotor plate 102 may be configurable into a second configuration 162 to be angled as desired (between 0° and 180° relative to airflow) and thus rotatable between the first configuration 160 and the third configuration 164 (not only vertically, but also horizontally) as desired. This may advantageously account for varying, shifting and/or unpredictable airflow patterns.

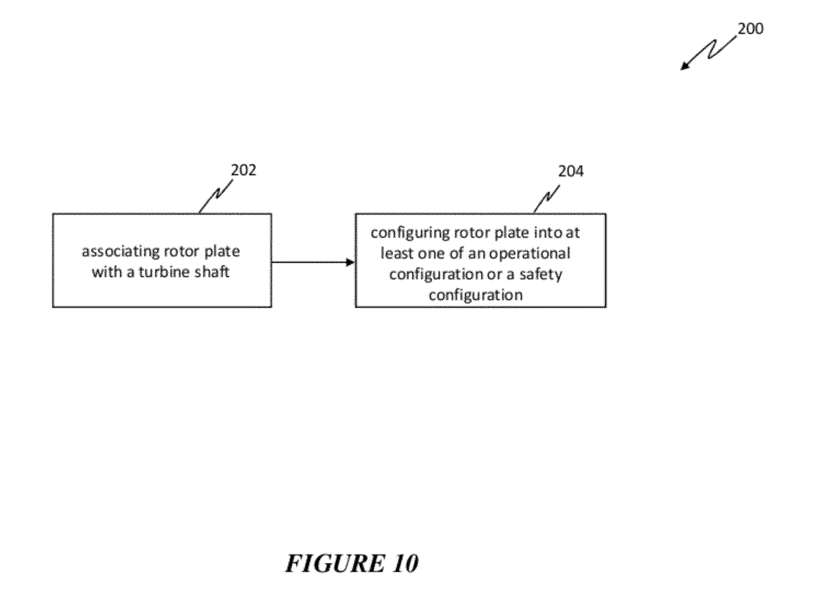

Referring to FIG. 10, an operational block diagram illustrating one embodiment of a method 200 for implementing the wheel rotor 100 is shown and includes associating the wheel rotor plate 102 with a turbine shaft 150 which is connected to electrical generation equipment 152, as shown in operational block 202. The wheel rotor 100 is then configured into at least one of the first configuration 160, the second configuration 162 or the third configuration 164. When in the first configuration 160, the wheel rotor plate 102 is configured to be substantially perpendicular to the direction of airflow. When in the third configuration 164 (i.e. the safety configuration), the wheel rotor plate 102 is substantially parallel to the direction of airflow, as shown in operational block 204. (It is contemplated that wheel rotor plate 102 may be in any of the first, second or third configurations). Thus, when the wheel rotor plate 102 is in the operational configuration 160, the airflow is incident on the rotor plate surface 110 and when the wheel rotor plate 102 is in the safety configuration 164, the airflow is incident on the back surface 120 of the blades 108. It should also be appreciated that the orientation of the wheel rotor plate 102 may be any orientation as desired suitable to the desired end purpose, such as perpendicular to the airflow, parallel to the airflow or anywhere in between. It should be further appreciated that the wheel rotor plate 102 may be configurable manually and/or automatically (such as in response to weather, wind characteristics (i.e. wind direction and speed) or other environmental conditions (such as lower/higher air density/pressure found in lower/higher altitudes) via a processing device. For example, if the wheel rotor plate 102 is located in an area that is below sea level (for example, death valley which is about 280 feet below sea level), the length and/or width of the blades 108 may be configured to be minimized to decrease the surface area of the blade because of the greater atmospheric pressure. Or, if the wheel rotor plate 102 is located in an area that is high above sea level (for example, Colorado which is about 10,000 feet above sea level), the length and/or width of the blades 108 may be configured to be maximized to increase the surface area of the blade because of the lower atmospheric pressure.

It should be appreciated that the wheel rotor plate 102 and/or the blades 108 may be constructed from any material or combination of materials suitable to the desired end purpose, such as metal (aluminum, steel, copper, etc.), metal alloys, fiberglass, wood, plastic, fiber-reinforced epoxy, unsaturated polyester, carbon fiber reinforced plastic, other composite material(s) and/or any combination thereof. Additionally, it is contemplated that one or more of the blades 108 may be integrated with the wheel rotor plate 102, in whole or in part, and/or one or more of the blades 108 may be connected to the wheel rotor plate 102 using any connecting device and/or method suitable to the desired end purpose, such as via welds, clips, bolts, etc. It is further contemplated that all or a portion of the blades 108 may be rotatable and/or angled as desired, via manually and/or automatically, to take advantage of changes in airflow variations. For example, a sensor may sense airflow changes, determine the preferred, desired and/or optimum orientation of the wheel rotor plate 102 and/or the blades 108 and automatically configure the wheel rotor plate 102 and/or the blades 108 or notify a technician to manually configure the wheel rotor plate 102 and/or the blades 108. It should be further appreciated that in at least one embodiment, one or more of the wheel blades 108 may be connected to an adjacent blade 106 via a horizontal member or strut as desired, such as for stability, structural support or other reason.

In accordance with the present invention, the processing of the method 200 in FIG. 10 may be implemented, wholly or partially, by a controller operating in response to a machine-readable computer program and in response to environmental sensor(s), such as flow sensors, electrical output sensors, etc. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing.

Moreover, the method of the present invention may be embodied in the form of a computer or controller implemented processes. The method of the invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

It should be appreciated that while the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A turbine rotor, comprising:
a rotor plate, the rotor plate being substantially circular in shape and including a rotor plate surface having a rotor plate center and a rotor plate periphery; and
a plurality of rotor blades, wherein the plurality of rotor blades are associated with the rotor plate to be located proximate the rotor plate periphery and to extend out of and away from the rotor plate surface,
wherein the rotor plate is configured to be attached to a turbine shaft that rotates about a shaft axis, such that when the turbine shaft rotates about the shaft axis, the rotor plate rotates about the shaft axis.

2. The turbine rotor of claim 1, wherein each of the plurality of rotor blades include a leading edge portion, a trailing edge portion, a blade center portion, a front surface and a back surface, wherein the leading edge portion is separated from the trailing edge portion by the blade center portion.

3. The turbine rotor of claim 2, wherein the leading edge portion is arcuate shaped.

4. The turbine rotor of claim 2, wherein the leading edge portion is configured at an angle of about 15°±15° relative to the blade center portion.

5. The turbine rotor of claim 2, wherein the trailing edge portion is configured at an angle of about 54°±15° relative to the blade center portion.

6. The turbine rotor of claim 1, wherein each of the plurality of rotor blades is separated from an adjacent rotor blade by a flow channel.

7. The turbine rotor of claim 1, wherein each of the plurality of rotor blades are positioned on the rotor plate to overlap each other, such that a portion of the leading edge portion of one blade, a portion of the trailing edge portion of an adjacent blade and the rotor plate center lie in a common sagittal plane.

8. The turbine rotor of claim 1, wherein a sagittal plane that intersects both the blade center portion and the rotor plate center is separated from a sagittal plane that is tangent to the blade center portion by an angle μ.

9. The turbine rotor of claim 8, wherein each of the plurality of rotor blades is configurable such that the angle μ is adjustable to be between about 0° and 90°.

10. A turbine system for converting fluid flow into electricity, the turbine system comprising:
a turbine rotor,
a rotor shaft, wherein the rotor shaft is associated with the turbine rotor such that rotation of the turbine rotor generates rotation of the rotor shaft; and
an electricity generation device, wherein the electricity generation device is associated with the rotor shaft and configured to generate electricity in response to the rotation of the rotor shaft,
wherein the turbine rotor includes a rotor plate, the rotor plate being substantially circular in shape and including a rotor plate surface having a rotor plate center and a rotor plate periphery; and
a plurality of rotor blades, wherein the plurality of rotor blades are associated with the rotor plate to be located proximate the rotor plate periphery and to extend out of and away from the rotor plate surface,
wherein the rotor plate is configured to be attached to a turbine shaft that rotates about a shaft axis, such that when the turbine shaft rotates about the shaft axis, the rotor plate rotates about the shaft axis.

11. The turbine system of claim 10, wherein each of the plurality of rotor blades include a leading edge portion, a trailing edge portion, a blade center portion, a front surface and a back surface, wherein the leading edge portion is separated from the trailing edge portion by the blade center portion.

12. The turbine system of claim 11, wherein the leading edge portion is arcuate shaped.

13. The turbine system of claim 11, wherein
the leading edge portion is configured at an angle of about 15°±15° relative to the blade center portion; and
the trailing edge portion is configured at an angle of about 54°±15° relative to the blade center portion.

14. The turbine system of claim 10, wherein each of the plurality of rotor blades is separated from an adjacent rotor blade by a flow channel.

15. The turbine system of claim 10, wherein at least a portion of the rotor shaft is configurable between a horizontal orientation and a vertical orientation.

16. The turbine system of claim 10, further comprising a processing device associated with at least one of the turbine rotor and the rotor shaft and configured to adjust a physical characteristic of at least one of the turbine rotor and the rotor shaft.

17. The turbine system of claim 16, further comprising a plurality of sensors in signal communication with the processing device, wherein the processing device is associated with at least one of the turbine rotor and the rotor shaft and configured to adjust a physical characteristic of at least one of the turbine rotor and the rotor shaft responsive to the plurality of sensors.

18. A method for converting a fluid flow into electrical energy, the method comprising:
associating a turbine rotor with an electrical energy generation device via a turbine shaft, such that rotation energy from the turbine rotor is communicated to the electrical generation device via the turbine shaft,
wherein the turbine rotor includes a rotor plate, the rotor plate being substantially circular in shape and including a rotor plate surface having a rotor plate center and a rotor plate periphery; and
a plurality of rotor blades, wherein the plurality of rotor blades are associated with the rotor plate to be located proximate the rotor plate periphery and to extend out of and away from the rotor plate surface,
wherein the rotor plate is configured to be attached to a turbine shaft that rotates about a shaft axis, such that when the turbine shaft rotates about the shaft axis, the rotor plate rotates about the shaft axis; and
positioning the turbine rotor such that at least a portion of a fluid flow is incident on the turbine rotor to cause the turbine rotor to generate rotational energy, wherein the rotational energy is received by the electrical energy generation device and converted into electrical energy.

19. The method of claim 18, wherein each of the plurality of rotor blades include a leading edge portion, a trailing edge portion, a blade center portion, a front surface and a back surface, wherein the leading edge portion is separated from the trailing edge portion by the blade center portion and wherein,
the leading edge portion is configured at an angle of about 15°±15° relative to the blade center portion; and
the trailing edge portion is configured at an angle of about 54°±15° relative to the blade center portion.

20. The method of claim 18, wherein a physical characteristic of the plurality of blades is configurable and wherein positioning further includes determining a characteristic of the fluid flow and adjusting a characteristic of at least one of the turbine rotor and the plurality of blades responsive to the characteristic of the fluid flow.
